(19) United States
(12) Patent Application Publication
(10) Pub. No.: US 2016/0048292 A1
(43) Pub. Date: Feb. 18, 2016

(54) TOUCH-SENSITIVE CONTROL DEVICE

(71) Applicant: Touchplus Information Corp., New Taipei City (TW)

(72) Inventors: Shih-Hsien Hu, New Taipei (TW); Yi- Feng Wei, New Taipei (TW); Yao-Chih Chuang, Tainan (TW)

(21) Appl. No.: 14/827,376

(22) Filed: Aug. 17, 2015

(30) Foreign Application Priority Data
Aug. 15, 2014 (CN) 201410401129.3

(51) Int. Cl. G06F 3/0481; G06F 3/041; G06F 3/0485; G06F 3/044

(52) U.S. Cl. CPC G06F 3/04812; G06F 3/044; G06F 3/0416; G06F 3/0485

(57) ABSTRACT

A control device includes a touch-sensing and displaying device detecting a touching operation or gesture thereon or thereover, generating a position information in response to the touching operation or gesture, and displaying a prompt information according to the position information; and a driver in communication with the touch-sensing and displaying device and the controlled system, issuing a first driving signal to the controlled system according to the position information for triggering at least one of the controlled units. A distribution of the prompt information in the touch-sensing and displaying device corresponds to a distribution of the triggered at least one of the controlled units in the controlled system.

### FIELD OF THE INVENTION

The present invention relates to a touch-sensitive control device, and more particularly to a touch-sensitive control device supporting remote control.

### BACKGROUND OF THE INVENTION

With the development of interactive electronic devices, particularly portable electronic communication devices such as smart phones and tablet computers, touch-sensing is more and more popular as a human-machine interface contributed to the intuitive and easy manipulation features. So far, capacitive touch sensors have been the mainstream of touch sensors.

For devices controlled with switch buttons or keys, the mechanical structures are disadvantageous in compactness and maintenance. Furthermore, if the devices are allocated as an array to be group controlled and distributed in a relatively large area, the control via a mechanical interface would be difficult.

### SUMMARY OF THE INVENTION

Therefore, the present invention provides a touch-sensitive control device supporting remote control in an intuitive and easy way.

An aspect of the present invention relates to a control device for controlling a controlled system. The controlled system includes a plurality of controlled units. The control device comprises: a touch-sensing and displaying device detecting a touching operation or gesture thereon or thereover, generating a position information in response to the touching operation or gesture, and displaying a prompt information according to the position information; and a driver in communication with the touch-sensing and displaying device and the controlled system, issuing a first driving signal to the controlled system according to the position information for triggering at least one of the controlled units, wherein a distribution of the prompt information in the touch-sensing and displaying device corresponds to a distribution of the triggered at least one of the controlled units in the controlled system.

In an embodiment, the touching operation or gesture includes a sliding operation, and the touch-sensing and displaying device further generates a shift information in response to the sliding operation or gesture, and the driver issues a second driving signal to the controlled system according to the shift information for driving the controlled system to conduct a fine-tuning operation.

Another aspect of the present invention relates to a control device for controlling a controlled system. The controlled system includes a plurality of controlled units. The control device comprises: a touch-sensing and displaying device detecting a series of touching operations or gestures thereon or thereover, generating a set of position information in response to the series of touching operations or gestures, and displaying a set of prompt patterns according to the set of position information; and a driver in communication with the touch-sensing and displaying device and the controlled system, issuing a first driving signal to the controlled system according to the set of position information for triggering a set of the controlled units, wherein a distribution of the prompt patterns in the touch-sensing and displaying device corresponds to a distribution of the triggered controlled units in the controlled system.

In an embodiment, the touching operation or gesture includes a sliding operation, the touch-sensing and displaying device further generates a shift information in response to the sliding operation or gesture, and the driver issues a second driving signal to the controlled system according to the shift information for driving the controlled system to conduct a fine-tuning operation.

In an embodiment, the touching operation or gesture includes a tapping operation, the touch-sensing and displaying device further generates a count information in response to the tapping operation or gesture, and the driver issues a third driving signal to the controlled system according to the count information for driving the controlled system to conduct a mode-switching operation.

In an embodiment, the touching operation or gesture includes a pressing operation, the touch-sensing and displaying device further generates a duration information in response to the pressing operation or gesture, and the driver issues a fourth driving signal to the controlled system according to the duration information for driving the controlled system to conduct a mode-triggering operation.

In an embodiment, the controlled units are allocated as an array, and are selected from a group consisting of lamps, sprinklers, electrochromic members and electric curtains, and the touch-sensing and displaying device includes an LED array. The LED array includes a plurality of LED modules selectively emitting light to show the set of prompt patterns.

In an embodiment, the prompt patterns are pictorial or literal patterns.

In an embodiment, the driver issues the first driving signal to the controlled units to be triggered according to the set of position information, and meanwhile the pictorial or literal patterns corresponding to the controlled units to be triggered according to the set of position information are shown or highlighted.

In an embodiment, the touch-sensing and displaying device includes: a touch sensor detecting the touching operations or gestures thereon or thereover, and generating the set of position information in response to the touching operations or gestures; and a plurality of light-emitting module disposed adjacent to the touch sensor, and selectively emitting light according to the set of position information to show the prompt patterns.

According to the present invention, a user can clearly identify the relative positions of the near-end control device and the remote-end controlled devices, thereby supporting remote control by way of touch-sensing means. The operation interface is easy and intuitive, and the structure is simplified.

### RIEF DESCRIPTION OF THE DRAWINGS

The invention will become more readily apparent to those ordinarily skilled in the art after reviewing the following detailed description and accompanying drawings, in which:

FIG. 1 is scheme illustrating a remote control between a touch-sensing control device and a controlled system according to an embodiment of the present invention;

FIG. 2 is a scheme illustrating an operation of the touch-sensing control device for remote control of the controlled system in an example of the embodiment as shown in FIG. 1; and

FIG. 3 is a scheme illustrating an operation of the touch-sensing control device for remote control of the controlled system in another example of the embodiment as shown in FIG. 1.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

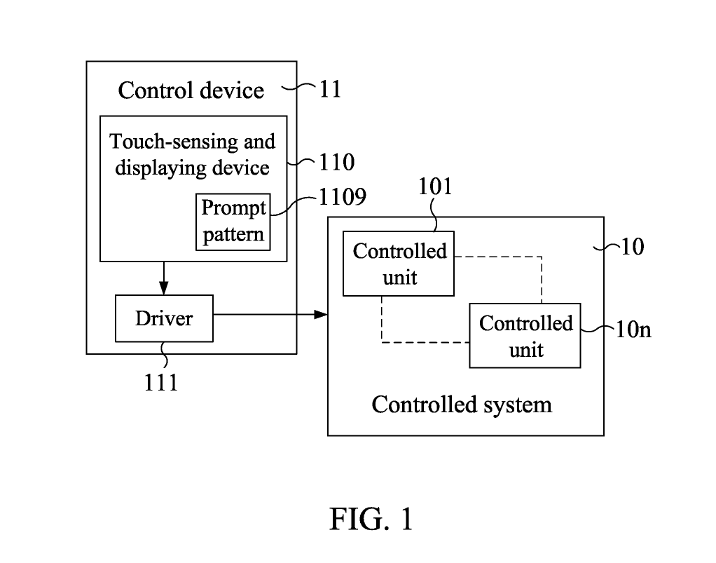

Referring to FIG. 1, a touch-sensing control device 11 according to an embodiment of the present invention is used to remotely control a controlled system 10, which includes an array of controlled units 101˜10n. The control device 11 includes a touch-sensing and displaying panel 110 and a driver 111. The touch-sensing and displaying panel 110 senses a user's touching operation or gesture thereon or thereover so as to generate a position information, or senses a series of user's touching operations or gestures thereon or thereover so as to generate a set of position information. It is to be noted that the term “touch-sensitive” or “touch-sensing” means not only to be sensitive to a sliding or touching gesture actually acting on a specified surface but also sensitive to an air gesture floatingly acting over the specified surface. The air gesture may be a vertically moving action and/or a horizontally moving action within a specified range, or a holding-still action for a specified period of time. Hereinafter, fingers are exemplified as the tool for executing the gestures. However, any other suitable tool capable of conducting a capacitance change may be used depending on practical requirements and size of the touch-sensing electronic device. For example, palms or conductive objects may also be used instead. For large-area touch sensing, a plurality of touch sensing units may be combined to detect a capacitance change so as to effectively enhance the sensitivity and effective sensible distance.

According to the position information or the set of position information, a prompt information will be displayed on the panel 110. The prompt information may include one or more pictorial and/or literal patterns. Meanwhile, the driver 111, which is in communication with the touch-sensing and displaying panel 110 and the controlled system 10, issues a first driving signal to the controlled system 10 according to the position information or the set of position information, thereby driving one or more of the controlled units 101˜10n associated with the displayed pattern or patterns to conduct a specific operation. For example, in response to a user's touching operation or gesture, a corresponding position information is generated and a pattern 1109 is displayed, for example on the right lower corner of the display 110. The pattern 1109 is preset to correspond to the controlled unit 10n, for example at the right lower corner of the controlled unit array. Accordingly, the driver 111 issues a driving signal to enable a default action of the controlled unit 10n.

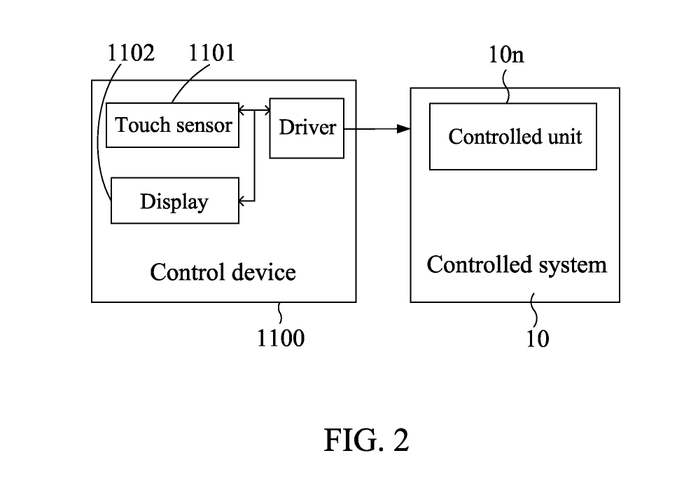

FIG. 2 is a scheme illustrating an operation of the touch-sensing control device for remote control of the controlled system in an example of the embodiment as shown in FIG. 1. The touch-sensing and displaying panel 110 includes a housing 1100, a touch sensor 1101 and a display 1102. The touch sensor 1101 and the display 1102 are integrated into the housing 1100 or onto a surface of the housing 1100. The touch sensor 1101 senses a user's touching operation or gesture on or over the housing 1100 so as to generate a position information. Meanwhile, a prompt information is generated and shown at a specific position on the display 1102 corresponding to the position information. For example, the touch sensor can be a capacitive touch sensor; and the display 1102 can be a planar display such as a light-emitting diode (LED) array or a liquid crystal display (LCD). In a specific example, the touch sensor 1101 and the display 1102 may overlap with each other. Accordingly, when a user conducts a touching operation or gesture on or over the housing 110 at a right lower corner, the touch sensor 1101 realizes the sensed location, generating a position information based on the sensed location, and transmits the position information to the display 1102 and the driver 111. The display 1102 shows a prompt information, e.g. a prompt pattern 1109, at a specific position according to the position information, and the driver 111 issues a first driving signal to the controlled system 10 according to the position information so as to trigger one or more of the controlled units corresponding to the specific position of the prompt pattern 1109, e.g. the controlled unit 10n. The prompt information is shown on the display 1102 for prompting the user of the triggered controlled unit or units.

In this example, the controlled units 101˜10n can be lamps, and selectively triggered to illuminate in a variety of combinations under the control of the control device 11 as described above. The display 1102 may previously show a layout of the controlled system 10, which includes a plurality of patterns, and the pattern or patterns associated with the selected controlled unit or units are marked, e.g. highlighted or color changed, to show the prompt information. Alternatively, the pattern or patterns associated with the selected controlled unit or units may be shown upon the conduction of the touching operation or gesture. The prompt information facilitates the confirmation of the selected controlled unit or units.

Extensively, the selected controlled unit or units or all the controlled units as a whole can be fine-tuned by the control device 11 based on another user's touching operation or gesture. For example, in response to sliding operation or gesture, the touch sensor generates a shift information. The driver 111 issues a second driving signal to the controlled system 10 to trigger the fine-tuning according to the shift information. For example, when the touch sensor 1101 detects a sliding shift from right to left in a specified or designated region, a corresponding shift information is generated. The driver 111 receives the shift information and in response, issues a driving signal to the controlled system 10 to trigger a fine-tuning operation of the controlled system, e.g. to raise the luminance of all or selected lamp or lamps. On the contrary, when the touch sensor 1101 detects a sliding shift from left to right in the specified or designated region, a corresponding shift information is generated. The driver 111 receives the shift information and in response, issues a driving signal to the controlled system 10 to trigger another fine-tuning operation of the controlled system, e.g. to lower the luminance of all or selected lamp or lamps.

In another example, when the touch sensor 1101 detects a downward sliding shift in the specified or designated region, a corresponding shift information is generated. The driver 111 receives the shift information and in response, issues a driving signal to the controlled system 10 to trigger a fine-tuning operation of the controlled system, e.g. to raise the color temperature of all or selected lamp or lamps. On the contrary, when the touch sensor 1101 detects an upward sliding shift in the specified or designated region, a corresponding shift information is generated. The driver 111 receives the shift information and in response, issues a driving signal to the controlled system 10 to trigger another fine-tuning operation of the controlled system, e.g. to lower the color temperature of all or selected lamp or lamps. The upward or downward sliding shift described herein may be a horizontal shift in parallel to the housing surface of the control device 10. Alternatively, with a specifically designed touch sensor, the upward or downward sliding shift described herein may also be a vertical shift normal to the housing surface of the control device 10.

Further extensively, a mode of the selected controlled unit or units or all the controlled units as a whole can be switched by the control device 11 based on another user's touching operation or gesture. For example, in response to a tapping operation or gesture, the touch sensor generates a count information. The driver 111 issues a third driving signal to the controlled system 10 to trigger the mode-switching according to the count information. For example, when the touch sensor 1101 detects a specified count of tapping, a corresponding count information is generated. The driver 111 receives the count information and in response, issues a driving signal to the controlled system 10 to trigger a mode-switching operation of the controlled system, e.g. to change colors of all or selected lamp or lamps. For example, different tapping counts and/or sequences result in different default colors.

Further extensively, a specific mode of the selected controlled unit or units or all the controlled units as a whole can be triggered by the control device 11 based on another user's touching operation or gesture. For example, a power-on or power-off control or power level control of the selected controlled unit or units or all the controlled units as a whole can be triggered by the control device 11 based on another user's touching operation or gesture. For example, in response to a pressing operation or gesture, the touch sensor generates a duration information. The driver 111 issues a fourth driving signal to the controlled system 10 to trigger the power-switching or power-adjusting operation according to the duration information. For example, when the touch sensor 1101 detects a pressing duration exceeding a threshold, a corresponding duration information is generated. The driver 111 receives the duration information and in response, issues a driving signal to the controlled system 10 to trigger a power-switching operation of the controlled system, e.g. to power on or power off all or selected lamp or lamps, or to change supplied power level of all or selected lamp or lamps.

In addition to lamps, the controlled units may also be, for example, sprinklers, electrochromic glass members, electric curtains or any other suitable devices or members to be group-controlled. According to the present invention, due to the clear position correlation of the controlled system to the control device, remote control of the controlled system can be achieved by conducting a touching operation or gesture on or over the control device. The remote control may include simple switch-on and switch-off operations. Furthermore, a variety of fine-tuning operations may also be included by way of corresponding designs. The parameters to be fine-tuned, for example, may include a sprayed water level of all or selected sprinkler or sprinklers, transmittance of all or selected electrochromic glass member or members, an open level of all or selected electric curtain or curtains, etc. The fine-tuning operations are conducted according to shift information generated in response to user's sliding shifts, as mentioned above. Likewise, prompt pattern or patterns generated in response to user's touching operation(s) or gesture(s) and corresponding to the selected controlled unit or units are shown on the display for reference or confirmation.

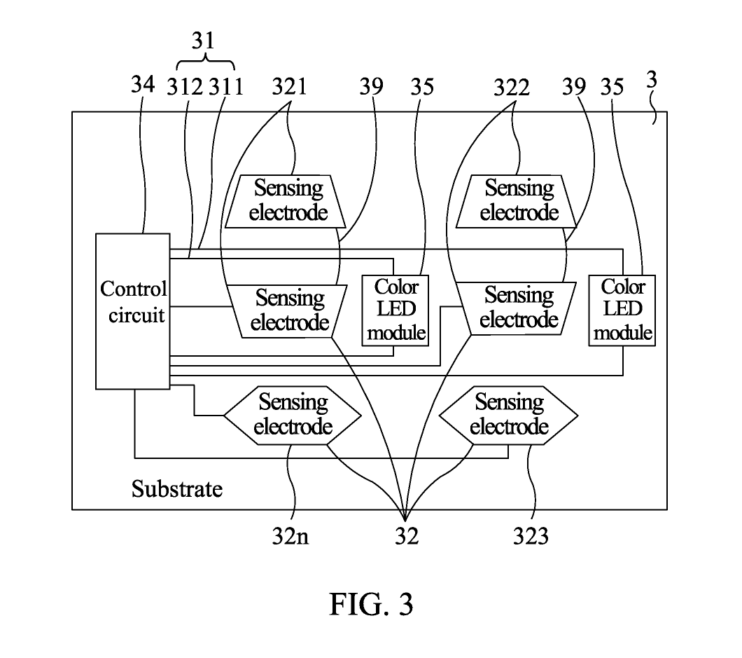

The touch-sensing and displaying panel 110 may alternatively be implemented with a structure as shown in FIG. 3. As shown, a first conductive structure 31 and a second conductive structure 32 are formed on the same surface of a substrate 3. The substrate 3 may be disposed on a surface of the housing 1100. Alternatively, the substrate 3 may be partially or entirely packed by the housing material by way of, for example, injection molding or any other suitable packaging technique, so as to be inserted inside the material of the housing 1100. The substrate 3 may be a single-layer single-face circuit board which is advantageous in low cost and simple manufacturing process. Of course, it can also be a single-layer double-face circuit board, or any other substrate adapted for the objectives of the present invention. The circuitry formed on the substrate 3 includes a control circuit 34 and one or more color LED modules 35 in addition to the first conductive structure 31 and the second conductive structure 32. One or more color LED modules 35 are electrically coupled to the first conductive structure 31 to receive power supply and control signals from the control circuit 34. The second conductive structure 32 includes a plurality of sensing electrodes 321˜32n typically arranged as one or more arrays for touch sensing. The second conductive structure 32 should be electrically isolated from the first conductive structure 31. Therefore, at the intersections of the sensing electrodes 321˜32n and power lines 311 and 312 associated with the first conductive structure 31, jumper wires 39 may be used for connecting the sensing electrodes. The jumper wires 39 may be provided onto the surface of the substrate 3 together with the color LED modules 35 in the same process or method, e.g. by way of surface mounting technology (SMT). Alternatively, other suitable means which electrically interconnects the sensing electrodes while electrically isolating the sensing electrodes 321˜32n from the power lines 311 and 312 may also be used, or the connecting lines between the sensing electrodes may just bypass the power lines 311 and 312, or the power lines 311 and 312 may bypass the sensing electrodes 321˜32n. If a single-layer double-face circuit board is used, via hole electric conduction may also be adopted. The number of the color LED modules depends on the distribution of the sensing electrodes in order that the control circuit 34 can calculate the position information and the shift information according to the sensed capacitance change of the sensing electrodes 321˜32n. Under this configuration, for example, one or more color LED modules 35 are turned on according to one or more corresponding touch-sensed points. A shift information may be generated in response to a sliding shift of a user on or over the touch-sensing and displaying device. One or more parameters, e.g. brightness or color, then change according to the shift information. Afterwards, another touching operation or gesture, e.g. double clicks, may be performed to transmit the settings to the controlled system 10 via the driver 111.

In view of the foregoing, by corresponding the configuration of the near-end control device to the layout of the remote-end controlled system, remote control can be achieved via an easy and intuitive touch-sensing interface according to the present invention. Furthermore, the touch-sensing interface exempts from bulky and damage problems generally encountered by a mechanical structure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control device for controlling a controlled system, the controlled system including a plurality of controlled units, the control device comprising:
a touch-sensing and displaying device detecting a touching operation or gesture thereon or thereover, generating a position information in response to the touching operation or gesture, and displaying a prompt information according to the position information; and
a driver in communication with the touch-sensing and displaying device and the controlled system, issuing a first driving signal to the controlled system according to the position information for triggering at least one of the controlled units, wherein a distribution of the prompt information in the touch-sensing and displaying device corresponds to a distribution of the triggered at least one of the controlled units in the controlled system.

2. The control device according to claim 1, wherein the touch-sensing and displaying device includes:
a housing;
a touch sensor detecting the touching operation or gesture thereon or thereover, and generating the position information in response to the touching operation or gesture; and
a display integrated into the housing together with the touch sensor and displaying the prompt information according to the position information.

3. The control device according to claim 2, wherein the touch sensor is a capacitive touch sensor and the display is an LED array or an LCD display.

4. The control device according to claim 1, wherein the touching operation or gesture includes a sliding operation, the touch-sensing and displaying device further generates a shift information in response to the sliding operation or gesture, and the driver issues a second driving signal to the controlled system according to the shift information for driving the controlled system to conduct a fine-tuning operation.

5. The control device according to claim 1, wherein the touching operation or gesture includes a tapping operation, the touch-sensing and displaying device further generates a count information in response to the tapping operation or gesture, and the driver issues a third driving signal to the controlled system according to the count information for driving the controlled system to conduct a mode-switching operation.

6. The control device according to claim 1, wherein the touching operation or gesture includes a pressing operation, the touch-sensing and displaying device further generates a duration information in response to the pressing operation or gesture, and the driver issues a fourth driving signal to the controlled system according to the duration information for driving the controlled system to conduct a mode-triggering operation.

7. The control device according to claim 1, wherein the controlled units are allocated as an array, and are selected from a group consisting of lamps, sprinklers, electrochromic members and electric curtains, and the touch-sensing and displaying device includes an LED array.

8. The control device according to claim 7, wherein the LED array includes a plurality of LED modules selectively emitting light to show the prompt information.

9. The control device according to claim 1, wherein the prompt information includes at least one pictorial or literal pattern.

10. The control device according to claim 9, wherein the driver issues the first driving signal to at least one of the controlled units to be triggered according to the position information, and meanwhile the at least one pictorial or literal pattern corresponding to the at least one of the controlled units to be triggered according to the position information is shown or highlighted.

11. The control device according to claim 1, wherein the touch-sensing and displaying device includes:
a touch sensor detecting the touching operation or gesture thereon or thereover, and generating the position information in response to the touching operation or gesture; and
at least one light-emitting module disposed adjacent to the touch sensor, and selectively emitting light according to the position information.

12. A control device for controlling a controlled system, the controlled system including a plurality of controlled units, the control device comprising:
a touch-sensing and displaying device detecting a series of touching operations or gestures thereon or thereover, generating a set of position information in response to the series of touching operations or gestures, and displaying a set of prompt patterns according to the set of position information; and
a driver in communication with the touch-sensing and displaying device and the controlled system, issuing a first driving signal to the controlled system according to the set of position information for triggering a set of the controlled units, wherein a distribution of the prompt patterns in the touch-sensing and displaying device corresponds to a distribution of the triggered controlled units in the controlled system.

13. The control device according to claim 12, wherein the touch-sensing and displaying device includes:
a housing;
a touch sensor detecting the set of touching operations or gestures thereon or thereover, and generating the set of position patterns in response to the touching operations or gestures; and
a display integrated into the housing together with the touch sensor and displaying the set of prompt patterns according to the set of position information.

14. The control device according to claim 13, wherein the touch sensor is a capacitive touch sensor and the display is an LED array or an LCD display.

15. The control device according to claim 12, wherein the touching operation or gesture includes a sliding operation, the touch-sensing and displaying device further generates a shift information in response to the sliding operation or gesture, and the driver issues a second driving signal to the controlled system according to the shift information for driving the controlled system to conduct a fine-tuning operation.

16. The control device according to claim 12, wherein the touching operation or gesture includes a tapping operation, the touch-sensing and displaying device further generates a count information in response to the tapping operation or gesture, and the driver issues a third driving signal to the controlled system according to the count information for driving the controlled system to conduct a mode-switching operation.

17. The control device according to claim 12, wherein the touching operation or gesture includes a pressing operation, the touch-sensing and displaying device further generates a duration information in response to the pressing operation or gesture, and the driver issues a fourth driving signal to the controlled system according to the duration information for driving the controlled system to conduct a mode-triggering operation.

18. The control device according to claim 12, wherein the controlled units are allocated as an array, and are selected from a group consisting of lamps, sprinklers, electrochromic members and electric curtains, and the touch-sensing and displaying device includes an LED array.

19. The control device according to claim 14, wherein the LED array includes a plurality of LED modules selectively emitting light to show the set of prompt patterns.

20. The control device according to claim 12, wherein the prompt patterns are pictorial or literal patterns.

21. The control device according to claim 20, wherein the driver issues the first driving signal to the controlled units to be triggered according to the set of position information, and meanwhile the pictorial or literal patterns corresponding to the controlled units to be triggered according to the set of position information are shown or highlighted.

22. The control device according to claim 12, wherein the touch-sensing and displaying device includes:
a touch sensor detecting the touching operations or gestures thereon or thereover, and generating the set of position information in response to the touching operations or gestures; and
a plurality of light-emitting module disposed adjacent to the touch sensor, and selectively emitting light according to the set of position information to show the prompt patterns.
